(19) United States
(12) Patent Application Publication
(10) Pub. No.: US 2016/0274634 A1
(43) Pub. Date: Sep. 22, 2016

(54) CONTROL METHOD FOR ELECTRONIC DEVICE, CONTROL DEVICE, AND ELECTRONIC DEVICE

(71) Applicant: LENOVO (BEIJING) CO., LTD., Beijing (CN)

(72) Inventors: Weixing SHI, Beijing (CN); Xueyuan ZHANG, Beijing (CN)

(73) Assignee: LENOVO (BEIJING) CO., LTD., Beijing (CN)

(21) Appl. No.: 14/431,964

(22) PCT Filed: Mar. 27, 2014
(86) PCT No.: PCT/CN2014/074158

§ 371 Date: Mar. 27, 2015

(30) Foreign Application Priority Data
Nov. 25, 2013 (CN) 201310606799.4

(51) Int. Cl. G06F 1/26; G06F 1/28

(52) U.S. Cl. CPC G06F 1/266; G06F 1/28

(57) ABSTRACT

The invention discloses a control method for an electronic device, wherein the electronic device includes a first assembly, a second assembly, a control device and a power supply device, the control method including: determining a position relation between the first assembly and the second assembly; determining a usage state of the electronic device based on the position relation; and controlling the power supply device to supply power to the electronic device, in a case that the usage state is a first state; or controlling the power supply device to supply power to only the control device, in a case that the usage state is a second state. It is further disclosed an electronic device and a control device for the electronic device in the invention.

This application claims the priority to Chinese Patent Application No. 201310606799.4, entitled “CONTROL METHOD FOR ELECTRONIC DEVICE, CONTROL DEVICE, AND ELECTRONIC DEVICE”, filed with the Chinese State Intellectual Property Office on Nov. 25, 2013, which is incorporated by reference in its entirety herein.

### FIELD

The present disclosure relates to the field of control technology applicable to an electronic device, and in particular to a control method for an electronic device, a control device, and an electronic device.

### BACKGROUND

For an electronic device which is powered by a power supply device (such as a battery or a storage battery) provided within the electronic device itself, such as an electronic pen, since electronic energy stored in the power supply device is limited, an problem to be solved by those skilled in the art is how to lengthen power supply endurance of the electronic device.

### SUMMARY

In view of this, an object of the disclosure is to provide an electronic device, a control device, and an electronic device, for lengthening power supply endurance of the electronic device by controlling a power-supplying process of the electronic device.

To achieve the above object, technical solutions are provided in the disclosure as follows.

It is disclosed a control method for an electronic device in the disclosure, wherein the electronic device includes a first assembly, a second assembly, a control device and a power supply device, the control method including:

determining a position relation between the first assembly and the second assembly;

determining a usage state of the electronic device, based on the position relation; and

controlling the power supply device to supply power to the electronic device, in a case that the usage state is a first state; or

controlling the power supply device to supply power to only the control device, in a case that the usage state is a second state.

Preferably, the first assembly and the second assembly may have a first position relation in a case that the second assembly is located at a first end of the first assembly, and the first assembly and the second assembly may have a second position relation in a case that the second assembly is located at a second end of the first assembly;

in the control method, the process of determining a usage state of the electronic device, based on the position relation, may include:
determining that the usage state of the electronic device is a first state in a case that the position relation is the first position relation; or
determining that the usage state of the electronic device is a second state in a case that the position relation is the second position relation.

Preferably, the power supply device may be provided inside the second assembly, a discharge contact and a detection contact may be provided at a bottom of the second assembly, a conductive layer may be provided at an end portion of the first end of the first assembly, the first end of the first assembly may be able to be placed inside the second assembly, and the conductive layer may be able to be in contact with the discharge contact and the detection contact;

in the control method, the process of determining a position relation between the first assembly and the second assembly may include:
judging whether there is an electrical signal on the detection contact; and
determining that the position relation between the first assembly and the second assembly is the first position relation in a case that there is an electrical signal on the detection contact; or
determining that the position relation between the first assembly and the second assembly is the second position relation in a case that there is no electrical signal on the detection contact.

Preferably, a first detection site may be provided at the first end of the first assembly, a second detection site may be provided at the second end of the first assembly, a first level signal may be output at the first detection site when the first detection site is in a pressed state, and a second level signal may be output at the first detection site when the first detection site is in an un-pressed state, a first level signal may be output at the second detection site when the second detection site is in a pressed state, and a second level signal may be output at the second detection site when the second detection site is in an un-pressed state;

in the control method, the process of determining a position relation between the first assembly and the second assembly may include:
detecting a level signal at the first detection site and a level signal at the second detection site; and
determining that the position relation between the first assembly and the second assembly is the first position relation in a case that the level signal at the first detection site is the first level signal; or
determining that the position relation between the first assembly and the second assembly is the second position relation in a case that the level signal at the second detection site is the first level signal.

A control device for an electronic device is further disclosed in the disclosure, wherein the electronic device further includes a first assembly, a second assembly and a power supply device, the control device including:

a position relation determination unit, configured to determine a position relation between the first assembly and the second assembly;

a usage state determination unit, configured to determine a usage state of the electronic device, based on the position relation;

a first control unit, configured to control the power supply device to supply power to the electronic device, in a case that the usage state is a first state; and

a second control unit, configured to control the power supply device to supply power to only the control device, in a case that the usage state is a second state.

Preferably, the first assembly and the second assembly may have a first position relation in a case that the second assembly is located at a first end of the first assembly, and the first assembly and the second assembly may have a second position relation in a case that the second assembly is located at a second end of the first assembly;

in the control device, the usage state determination unit may include:
a first usage state determination module, configured to determine that the usage state of the electronic device is a first state in a case that the position relation is the first position relation; and
a second usage state determination module, configured to determine that the usage state of the electronic device is a second state in a case that the position relation is the second position relation.

Preferably, the power supply device may be provided inside the second assembly, a discharge contact and a detection contact may be provided at a bottom of the second assembly, a conductive layer may be provided at an end portion of the first end of the first assembly, the first end of the first assembly may be able to be placed inside the second assembly, and the conductive layer may be able to be in contact with the discharge contact and the detection contact;

in the control device, the position relation determination unit may include:
a judgment module, configured to judge whether there is an electrical signal on the detection contact;
a first determination module, configured to determine that the position relation between the first assembly and the second assembly is the first position relation in a case that there is an electrical signal on the detection contact; and
a second determination module, configured to determine that the position relation between the first assembly and the second assembly is the second position relation in a case that there is no electrical signal on the detection contact.

Preferably, a first detection site may be provided at the first end of the first assembly, a second detection site may be provided at the second end of the first assembly, a first level signal may be output at the first detection site when the first detection site is in a pressed state, and a second level signal may be output at the first detection site when the first detection site is in an un-pressed state, a first level signal may be output at the second detection site when the second detection site is in a pressed state, and a second level signal may be output at the second detection site when the second detection site is in an un-pressed state;

in the control device, the position relation determination unit may include:
a detection unit, configured to detect a level signal at the first detection site and a level signal at the second detection site;
a third determination module, configured to determine that the position relation between the first assembly and the second assembly is the first position relation in a case that the level signal at the first detection site is the first level signal; and
a fourth determination module, configured to determine that the position relation between the first assembly and the second assembly is the second position relation in a case that the level signal at the second detection site is the first level signal.

An electronic device is further disclosed in the disclosure, which includes a first assembly, a second assembly, a power supply device and the control device according to any one control device above.

As can be seen, the disclosure has benefit advantages as follows. With the control method for the electronic device disclosed in the disclosure, the position relation between the first assembly and the second assembly is determined firstly, and then the usage state of the electronic device is determined based on the position relation between the first assembly and the second assembly. Only the control device in the electronic device is powered in the case that the electronic device is determined to be in the second state. Thus, power consumption of the electronic device is reduced, and power supply endurance of the electronic device is lengthened.

### BRIEF DESCRIPTION OF THE DRAWINGS

In order to illustrate the technical solutions in the embodiments of the disclosure or in the conventional art more clearly, drawings to be used in describing the conventional art or the embodiments of the disclosure will be described briefly hereinafter. Apparently, the drawings described hereinafter are merely some embodiments of the disclosure, and other drawings may be obtained by those ordinarily skilled in the art based on those drawings without creative labor.

FIG. 1 is a flow chart of a control method for an electronic device disclosed in the disclosure;

FIG. 2 is a flow chart of another control method for an electronic device disclosed in the disclosure;

FIG. 3 is a flow chart of another control method for an electronic device disclosed in the disclosure;

FIG. 4 is a flow chart of a control method for an electronic pen disclosed in the disclosure; and

FIG. 5 is a schematic structural diagram of a control device for an electronic device disclosed in the disclosure.

### DETAILED DESCRIPTION

To illustrate the objects, technical solutions and advantages of the present disclosure more clearly, the technical solutions in the embodiments of the present disclosure will be described clearly and completely hereinafter in conjunction with the drawings in the embodiments of the present disclosure. Apparently, the described embodiments are merely some but not all embodiments of the present disclosure. All other embodiments obtained by those ordinarily skilled in the art based on the embodiments of the present disclosure without creative work fall within the scope of protection of the present disclosure.

A control method for an electronic device is disclosed in the disclosure, for lengthening power supply endurance of the electronic device by controlling a power-supplying process of the electronic device. The electronic device includes a first assembly, a second assembly, a control device and a power supply device. The power supply device is configured to supply power to the control device and other electrical units in the electronic device. The electronic device may be an electronic pen, where the first assembly refers to a main body of the electronic pen, and the second assembly refers to a pen cap of the electronic pen.

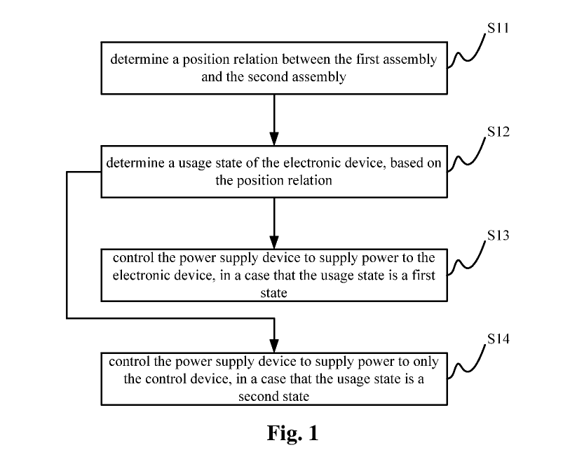

Reference is made to FIG. 1, which is a flow chart of a control method for an electronic device disclosed in the disclosure. The control method includes steps S11 to S14 as follows.

In step S11, a position relation between the first assembly and the second assembly is determined.

The first assembly and the second assembly of the electronic device may have various different position relations. For example, the second assembly may be located at a first end of the first assembly, or may be located at a second end of the first assembly. The first assembly and the second assembly have a position relation in a case that the electronic device is in a first state; and the first assembly and the second assembly have another position relation in a case that the electronic device is in a second state. The first state may be an operation state, and the second state may be an idle state.

In step S12, a usage state of the electronic device is determined based on the position relation.

The position relation between the first assembly and the second assembly of the electronic device varies with the usage state of the electronic device. Thus, the usage state of the electronic device may be determined based on the position relation between the first assembly and the second assembly.

In step S13, the power supply device is controlled to supply power to the electronic device, in a case that the usage state is a first state.

In step S14, the power supply device is controlled to supply power to only the control device, in a case that the usage state is a second state.

In a case that the electronic device is in the first state, it indicates that the electronic device is being used by a user, and the power supply device needs to supply power to the integral electronic device. That is to say, the power supply device needs to supply power not only to the control device but also to other electrical units in the electronic devices, for ensuring a normal operation of the electronic device. It indicates that the electronic device is not being used by a user currently in a case that the electronic device is in the second state, the electronic device is in the idle state, and the power supply device needs to supply power to only the control device in the electronic device, for reducing power consumption of the electronic device and lengthening the power supply endurance of the electronic device.

With the control method for the electronic device disclosed in the disclosure, the position relation between the first assembly and the second assembly is determined firstly, and then the usage state of the electronic device is determined based on the position relation between the first assembly and the second assembly. Only the control device in the electronic device is powered in the case that the electronic device is determined to be in the second state. Thus, power consumption of the electronic device is reduced, and power supply endurance of the electronic device is lengthened.

In the disclosure, it is determined that the position relation between the first assembly and the second assembly is a first position relation in a case that the second assembly is located at a first end of the first assembly, and it is determined that the position relation between the first assembly and the second assembly is a second position relation in a case that the second assembly is located at a second end of the first assembly. The process of determining a usage state of the electronic device based on the position relation includes:

determining that the usage state of the electronic device is a first state in a case that the position relation is the first position relation; or determining that the usage state of the electronic device is a second state in a case that the position relation is the second position relation.

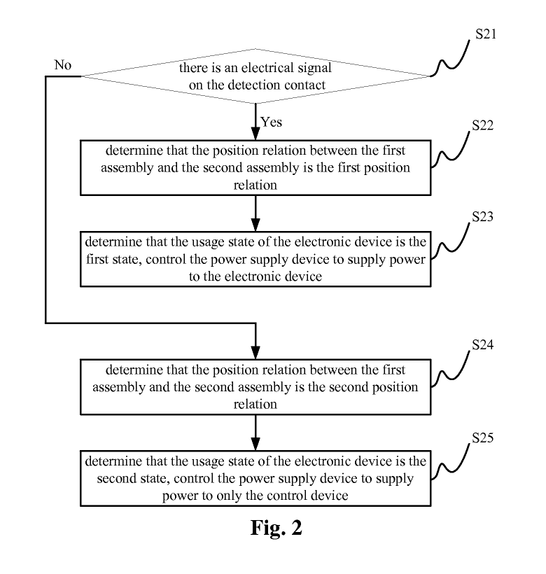

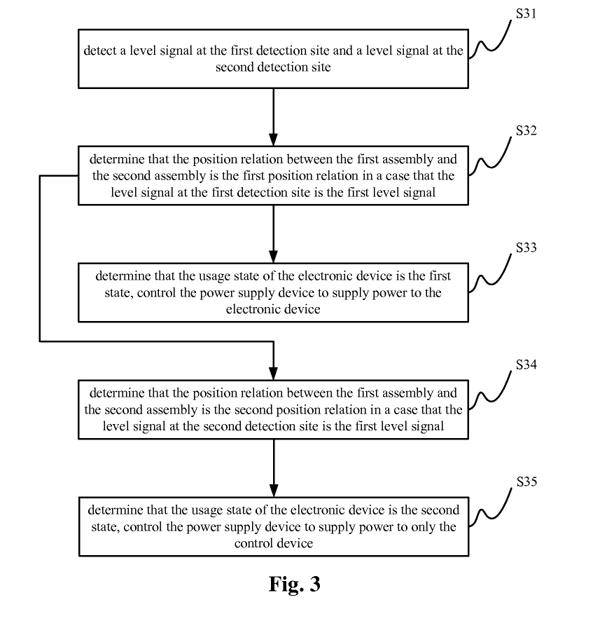

In implementation, the position relation between the first assembly and the second assembly may be determined using methods described hereinafter in conjunction with FIG. 2 and FIG. 3.

Reference is made to FIG. 2, which is a flow chart of another control method for an electronic device disclosed in the disclosure. In the electronic device, the power supply device is provided inside the second assembly, a discharge contact and a detection contact are provided at a bottom of the second assembly, a conductive layer is provided at an end portion of a first end of the first assembly, the first end of the first assembly is able to be placed inside the second assembly, and the conductive layer is able to be in contact with the discharge contact and the detection contact. The control method includes steps S21 to S25 as follows.

In step S21, it is judged whether there is an electrical signal on the detection contact, the control method proceeds to step S22 if there is an electrical signal, or the control method proceeds to step S24 if there is no electrical signal.

The discharge contact and the detection contact each are provided at the bottom of the second assembly, and there is no electrical signal on the detection contact if the discharge contact and the detection contact are not connected via a conductive medium. When the first end of the first assembly is placed inside the second assembly, the conductive layer provided at the end portion of the first end of the first assembly becomes in contact with the discharge contact and the detection contact, the discharge contact, the conductive layer and the detection contact form a closed circuit, and there is an electrical signal on the detection contact. Thus, the position relation between the first assembly and the second assembly may be judged by judging whether there is an electrical signal on the detection contact.

In step S22, it is determined that the position relation between the first assembly and the second assembly is a first position relation, and the control method proceeds to step S23.

In step S23, it is determined that a usage state of the electronic device is a first state, and the power supply device is controlled to supply power to the electronic device.

In a case that there is an electrical signal on the detection contact, it indicates that the first end of the first assembly is located inside the second assembly. That is to say, the second assembly is provided at the first end of the first assembly. In this case, it is determined that the usage state of the electronic device is the first state, and the power supply device is controlled to supply power to the integral electronic device.

It is to be noted, the conductive layer at the end portion of the first end of the first assembly is connected to the electrical unit inside the first assembly, and thus the power supply device provided inside the second assembly may supply power to the electrical unit provided inside the first assembly via the conductive layer.

In step S24, it is determined that the position relation between the first assembly and the second assembly is a second position relation.

In step S25, it is determined that the usage state of the electronic device is a second state, and the power supply device is controlled to supply power to only the control device.

In a case that there is no electrical signal on the detection contact, it is deemed that the second end of the first assembly is located inside the second assembly. That is to say, the second assembly is provided at the second end of the first assembly. In this case, it is determined that the usage state of the electronic device is the second state, and the power supply device is controlled to supply power to only the control device.

With the control method for the electronic device disclosed above in the disclosure, the conductive layer is provided at the end portion of the first end of the first assembly of the electronic device, and the discharge contact and the detection contact are provided at the bottom of the second assembly of the electronic device. When the first end of the first assembly is placed inside the second assembly, the conductive layer of the first assembly becomes in contact with the discharge contact and the detection contact in the second assembly to form a closed circuit, so that there is an electrical signal on the detection contact. Then the control device judges whether there is an electrical signal on the detection contact to determine the position relation between the first assembly and the second assembly, thereby achieving power supply control of the electronic device, ensuring that the power supply device supplies power to only the control device when the electronic device is in the second state, reducing power consumption of the electronic device, and lengthening power supply endurance of the electronic device.

Reference is made to FIG. 3, which is a flow chart of another control method for an electronic device disclosed in the disclosure. In the electronic device, a first detection site is provided at a first end of the first assembly, a second detection site is provided at a second end of the first assembly, a first level signal is output at the first detection site when the first detection site is in a pressed state, and a second level signal is output at the first detection site when the first detection site is in an un-pressed state; a first level signal is output at the second detection site when the second detection site is in a pressed state, and a second level signal is output at the second detection site when the second detection site is in an un-pressed state. The control method includes steps S31 to S35 as follows.

In step S31, a level signal at the first detection site and a level signal at the second detection site are detected.

A first detection site may be provided at the first end of the first assembly of the electronic device, a second detection site may be provided at the second end of the first assembly. When the first end of the first assembly is placed inside the second assembly, the second assembly presses the first detection site. In this case, the first detection site outputs the first level signal. When the second end of the first assembly is placed inside the second assembly, the second assembly presses the second detection site. In this case, the second detection site outputs a first level signal. Therefore, the position relation between the first assembly and the second assembly can be determined by detecting the level signal at the first detection site and the level signal at the second detection site.

In step S32, it is determined that the position relation between the first assembly and the second assembly is the first position relation in a case that the level signal at the first detection site is the first level signal, and the control method proceeds to step S33.

In step S33, it is determined that the usage state of the electronic device is a first state, and the power supply device is controlled to supply power to the electronic device.

In a case that the level signal at the first detection site is the first level signal, it indicates that the first end of the first assembly is located inside the second assembly. That is to say, the second assembly is provided at the first end of the first assembly. In this case, it is determined that the usage state of the electronic device is the first state, and the power supply device is controlled to supply power to the integral electronic device.

In step S34, it is determined that the position relation between the first assembly and the second assembly is a second position relation in a case that the level signal at the second detection site is the first level signal.

In step S35, it is determined that the usage state of the electronic device is a second state, and the power supply device is controlled to supply power to only the control device.

In a case that the level signal at the second detection site is the first level signal, it indicates that the second end of the first assembly is located inside the second assembly. That is to say, the second assembly is provided at the second end of the first assembly. In this case, it is determined that the usage state of the electronic device is the second state, and the power supply device is controlled to supply power to only the control device.

With the control method for the electronic device disclosed above in the disclosure, the first detection site is provided at the first end of the first assembly, the second detection site is provided at the second end of the first assembly, and the first level signal is output at the first detection site when the first detection site is in a pressed state; and a first level signal is output at the second detection site when the second detection site is in a pressed state. Thus the position relation between the first assembly and the second assembly may be determined by detecting the level signal at the first detection site and the level signal at the second detection site, thereby achieving power supply control of the electronic device, ensuring that the power supply device supplies power to only the control device when the electronic device is in the second state, reducing power consumption of the electronic device, and lengthening power supply endurance of the electronic device.

The electronic device in the disclosure may be an electronic pen, which is a new type data input device. When a writing process is performed on a writing medium by using the electronic pen, the electronic pen recognizes written characters and images and transmits the recognized characters and images to a related electronic device. The electronic pen includes a pen body, a pen cap, a control device, a main circuit (including a data processing circuit and a communication circuit) and a power supply device. The control device and the power supply device are provided inside the pen cap. The main circuit is provided inside the pen body. The pen body may be considered as a first assembly. The pen cap may be considered as a second assembly. Specifically, a head of the pen body (that is an end of the electronic pen nearer to the writing medium when the electronic pen is used by a user to perform an input operation) is considered as a second end of the first assembly. A tail of the pen body is considered as a first end of the first assembly.

Reference is made to FIG. 4, which is a flow chart of a control method for an electronic pen disclosed in the disclosure. The control method includes steps S41 to S43 as follows.

In step S41, a position relation between the pen body and the pen cap of the electronic pen is determined.

When the electronic pen is used by a user to input, the pen cap of the electronic pen is generally placed at the tail of the pen body; and when the electronic pen is no longer used by the user, the head of the pen body of the electronic pen is generally inserted into the pen cap. Thus, it may be determined, based on the position relation between the pen body and the pen cap, whether to supply power to each of the electrical units in the electronic pen.

In implementation, the position relation between the pen body and the pen cap of the electronic pen may be determined using the methods shown in FIG. 2 and FIG. 3. Specifically, a first detection site is provided at the tail of the pen body, and a second detection site is provided at the head of the pen body. The control device detects the level signal at the first detection site and the level signal at the second detection site. In a case that the level signal at the first detection site is the first level signal, it is determined that the tail of the pen body of the electronic pen is inserted inside the pen cap, i.e., it is determined that the pen cap is located at the tail of the pen body. In a case that the level signal at the second detection site is the first level signal, it is determined that the head of the pen body of the electronic pen is inserted inside the pen cap, i.e., it is determined that the pen cap is located at the head of the pen body. Alternatively, a conductive layer is provided at the tail of the pen body, and a discharge contact and a detection contact are provided at the bottom inside the pen cap. When the pen cap is placed at the tail of the pen body, the conductive layer becomes in contact with the discharge contact and the detection contact. The control device judges whether there is an electrical signal at the detection contact; determines that the tail of the pen body of the electronic pen is inserted inside the pen cap, i.e., that the pen cap is located at the tail of the pen body, in a case that there is an electrical signal at the detection contact; or else determines that the head of the pen body of the electronic pen is inserted inside the pen cap, i.e., that the pen cap is located at the head of the pen body.

In step S42, it is determined that the electronic pen is in a first state in a case that the pen cap is located at the tail of the pen body, and the electronic device is controlled to supply power to the electronic pen.

In step S43, it is determined that the electronic pen is in a second state in a case that the pen cap is located at the head of the pen body, and the power supply device is controlled to supply power to only the control device.

With the control method shown in FIG. 4, the power supply device can be controlled to supply power to only the control device when the electronic pen is not used by the user, thereby reducing power consumption of the electronic device, and lengthening power supply endurance of the electronic device. Certainly, by using a main switch provided on the electronic pen, a user may further controls the electronic pen to completely stop operating. In this case, the power supply device no longer outputs electrical energy, and no longer supplies power to the control device.

The control method for the electronic device is disclosed above in the disclosure. Accordingly, a control device for an electronic device is disclosed in the disclosure, for implementing the control method. The electronic device includes a first assembly, a second assembly, the control device and a power supply device. The power supply device is configured to supply power to the control device and other electrical units in the electronic device. The electronic device may be an electronic pen, where the first assembly refers to a main body of the electronic pen, and the second assembly refers to a pen cap of the electronic pen.

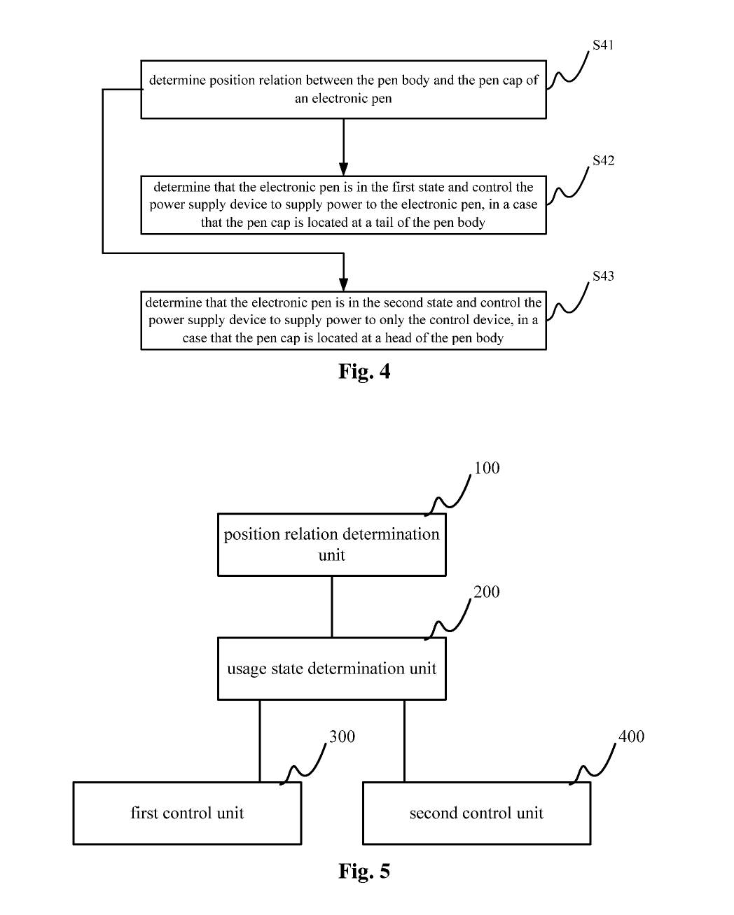

Reference is made to FIG. 5, which is a schematic structural diagram of a control device for an electronic device disclosed in the disclosure. The control device includes a position relation determination unit 100, a usage state determination unit 200, a first control unit 300 and a second control unit 400.

The position relation determination unit 100 is configured to determine a position relation between the first assembly and the second assembly.

The usage state determination unit 200 is configured to determine a usage state of the electronic device, based on the position relation determined by the position relation determination unit 100.

The first control unit 300 is configured to control the power supply device to supply power to the electronic device, in a case that the usage state of the electronic device is a first state.

The second control unit 400 is configured to control the power supply device to supply power to only the control device, in a case that the usage state of the electronic device is a second state.

With the control device for the electronic device disclosed in the disclosure, the position relation between the first assembly and the second assembly is determined firstly, and then the usage state of the electronic device is determined based on the position relation between the first assembly and the second assembly. Only the control device in the electronic device is powered in the case that the electronic device is determined to be in the second state.

Thus, power consumption of the electronic device is reduced, and power supply endurance of the electronic device is lengthened.

In the disclosure, it is determined that the position relation between the first assembly and the second assembly is a first position relation in a case that the second assembly is located at a first end of the first assembly, and it is determined that the position relation between the first assembly and the second assembly is a second position relation in a case that the second assembly is located at a second end of the first assembly.

Accordingly, the usage state determination unit includes a first usage state determination module and a second usage state determination module.

The first usage state determination module is configured to determine that the usage state of the electronic device is a first state in a case that the position relation is the first position relation.

The second usage state determination module is configured to determine that the usage state of the electronic device is a second state in a case that the position relation is the second position relation.

In implementation, the position relation between the first assembly and the second assembly may be determined using various methods.

For example, in the electronic device, the power supply device is provided inside the second assembly, a discharge contact and a detection contact are provided at a bottom of the second assembly, a conductive layer is provided at an end portion of the first end of the first assembly, the first end of the first assembly is able to be placed inside the second assembly, and the conductive layer is able to be in contact with the discharge contact and the detection contact.

In this case, the position relation determination unit 100 includes: a judgment module, configured to judge whether there is an electrical signal on the detection contact; a first determination module, configured to determine that the position relation between the first assembly and the second assembly is the first position relation in a case that there is an electrical signal on the detection contact; and a second determination module, configured to determine that the position relation between the first assembly and the second assembly is the second position relation in a case that there is no electrical signal on the detection contact.

For another example, in the electronic device, a first detection site is provided at the first end of the first assembly, a second detection site is provided at the second end of the first assembly, a first level signal is output at the first detection site when the first detection site is in a pressed state, and a second level signal is output at the first detection site when the first detection site is in an un-pressed state; and a first level signal is output at the second detection site when the second detection site is in a pressed state, and a second level signal is output at the second detection site when the second detection site is in an un-pressed state.

In this case, the position relation determination unit 100 includes: a detection unit, configured to detect a level signal at the first detection site and a level signal at the second detection site; a third determination module, configured to determine that the position relation between the first assembly and the second assembly is the first position relation in a case that the level signal at the first detection site is the first level signal; and a fourth determination module, configured to determine that the position relation between the first assembly and the second assembly is the second position relation in a case that the level signal at the second detection site is the first level signal.

In another aspect, it is disclosed an electronic device in the disclosure. The electronic device includes a first assembly, a second assembly, a control device and a power supply device. The control device is any one of the control devices disclosed above in the disclosure. When the electronic device disclosed in the disclosure is in an idle state, the power supply device in the electronic device supplies power to only the control device, thereby reducing power consumption and lengthening power supply endurance.

In the present specification, the embodiments are described in a progressive manner. Each embodiment mainly emphasizes an aspect difference from other embodiments, and reference can be made to these similar parts among the embodiments. The device disclosed in the embodiment corresponds to the method disclosed in the embodiment, and is described briefly. For detailed description of the device, reference may be made to the related description of the method.

It is further understood by those skilled in the art, the exemplary units in conjunction with the algorithm steps in the examples that are described in the disclosure are able to be implemented in electronic hardware, computer software or a combination thereof, and the components and the steps of the examples have been generally described according to the functions in the above description, for clearly describing the interchangeability between the hardware and the software. Whether these functions are implemented in hardware or software is determined by technical solution-specific applications and design constraint conditions. For each specific application, the described function can be implemented using a different method by those skilled in the art, and this application should not be considered as beyond the scope of the present invention.

Conjunction of the steps of the methods or the algorithms that are described in the embodiments disclosed herein can be implemented in hardware, a software module performed by a processor or a combination thereof. A software module can be in a Random Access Memory (RAM), a memory, a Read-Only Memory (ROM), an electrically programmable ROM, an electrically erasable programmable ROM, a register, a hard disk, a movable disk, a CD-ROM, or any other forms of storing medium that is well-known in the technical field.

The above description of the disclosed embodiments enables those skilled in the art to implement or use the present disclosure. Many modifications made to these embodiments will be obvious to those skilled in the art, and the general principles defined in the present disclosure can be implemented in other embodiments without departing from the spirit or the scope of the present disclosure. Therefore, the present disclosure should not be limited to these embodiments disclosed herein, but should be in line with the widest scope in accordance with the principles and the novel characteristics disclosed by the present disclosure.

1. A control method for an electronic device, wherein the electronic device comprises a first assembly, a second assembly, a control device and a power supply device, the control method comprising:
determining a position relation between the first assembly and the second assembly;
determining a usage state of the electronic device, based on the position relation; and
controlling the power supply device to supply power to the electronic device, in a case that the usage state is a first state; or
controlling the power supply device to supply power to only the control device, in a case that the usage state is a second state.

2. The control method according to claim 1, wherein the position relation between the first assembly and the second assembly is a first position relation in a case that the second assembly is located at a first end of the first assembly, and the position relation between the first assembly and the second assembly is a second position relation in a case that the second assembly is located at a second end of the first assembly;
the process of determining a usage state of the electronic device, based on the position relation, comprises:
determining that the usage state of the electronic device is a first state in a case that the position relation is the first position relation; or
determining that the usage state of the electronic device is a second state in a case that the position relation is the second position relation.

3. The control method according to claim 2, wherein the power supply device is provided in the second assembly, a discharge contact and a detection contact are provided at a bottom of the second assembly, a conductive layer is provided at an end portion of the first end of the first assembly, the first end of the first assembly is able to be placed inside the second assembly, and the conductive layer is able to be in contact with the discharge contact and the detection contact; and
the process of determining a position relation between the first assembly and the second assembly comprises:
judging whether there is an electrical signal on the detection contact; and
determining that the position relation between the first assembly and the second assembly is the first position relation in a case that there is an electrical signal on the detection contact; or
determining that the position relation between the first assembly and the second assembly is the second position relation in a case that there is no electrical signal on the detection contact.

4. The control method according to claim 2, wherein a first detection site is provided at the first end of the first assembly, a second detection site is provided at the second end of the first assembly, a first level signal is output at the first detection site when the first detection site is in a pressed state, and a second level signal is output at the first detection site when the first detection site is in an un-pressed state, a first level signal is output at the second detection site when the second detection site is in a pressed state, and a second level signal is output at the second detection site when the second detection site is in an un-pressed state; and
the process of determining a position relation between the first assembly and the second assembly comprises:
detecting a level signal at the first detection site and a level signal at the second detection site; and
determining that the position relation between the first assembly and the second assembly is the first position relation in a case that the level signal at the first detection site is the first level signal; or
determining that the position relation between the first assembly and the second assembly is the second position relation in a case that the level signal at the second detection site is the first level signal.

5. A control device for an electronic device, wherein the electronic device further comprises a first assembly, a second assembly and a power supply device, the control device comprising:
a position relation determination unit, configured to determine a position relation between the first assembly and the second assembly;
a usage state determination unit, configured to determine a usage state of the electronic device, based on the position relation;
a first control unit, configured to control the power supply device to supply power to the electronic device, in a case that the usage state is a first state; and
a second control unit, configured to control the power supply device to supply power to only the control device, in a case that the usage state is a second state.

6. The control device according to claim 5, wherein the position relation between the first assembly and the second assembly is a first position relation in a case that the second assembly is located at a first end of the first assembly, and the position relation between the first assembly and the second assembly is a second position relation in a case that the second assembly is located at a second end of the first assembly;
the usage state determination unit comprises:
a first usage state determination module, configured to determine that the usage state of the electronic device is a first state in a case that the position relation is the first position relation; and
a second usage state determination module, configured to determine that the usage state of the electronic device is a second state in a case that the position relation is the second position relation.

7. The control device according to claim 6, wherein the power supply device is provided inside the second assembly, a discharge contact and a detection contact are provided at a bottom of the second assembly, a conductive layer is provided at an end portion of the first end of the first assembly, the first end of the first assembly is able to be placed inside the second assembly, and the conductive layer is able to be in contact with the discharge contact and the detection contact; and
the position relation determination unit comprises:
a judgment module, configured to judge whether there is an electrical signal on the detection contact;
a first determination module, configured to determine that the position relation between the first assembly and the second assembly is the first position relation in a case that there is an electrical signal on the detection contact; and
a second determination module, configured to determine that the position relation between the first assembly and the second assembly is the second position relation in a case that there is no electrical signal on the detection contact.

8. The control device according to claim 6, wherein a first detection site is provided at the first end of the first assembly, a second detection site is provided at the second end of the first assembly, a first level signal is output at the first detection site when the first detection site is in a pressed state, and a second level signal is output at the first detection site when the first detection site is in an un-pressed state, a first level signal is output at the second detection site when the second detection site is in a pressed state, and a second level signal is output at the second detection site when the second detection site is in an un-pressed state; and
the position relation determination unit comprises:
a detection unit, configured to detect a level signal at the first detection site and a level signal at the second detection site;
a third determination module, configured to determine that the position relation between the first assembly and the second assembly is the first position relation in a case that the level signal at the first detection site is the first level signal; and
a fourth determination module, configured to determine that the position relation between the first assembly and the second assembly is the second position relation in a case that the level signal at the second detection site is the first level signal.

9. An electronic device, comprising a first assembly, a second assembly, a control device and a power supply device, wherein the control device is the one according to claim 5.
